(19) United States
(12) Patent Application Publication
(10) Pub. No.: US 2014/0309992 A1
(43) Pub. Date: Oct. 16, 2014

(54) METHOD FOR DETECTING, IDENTIFYING, AND ENHANCING FORMANT FREQUENCIES IN VOICED SPEECH

(71) Applicant: UNIVERSITY OF ROCHESTER, ROCHESTER, NY (US)

(72) Inventor: Laurel H. Carney, Geneva, NY (US)

(73) Assignee: UNIVERSITY OF ROCHESTER, ROCHESTER, NY (US)

(21) Appl. No.: 14/254,267

(22) Filed: Apr. 16, 2014

Related U.S. Application Data
(60) Provisional application No. 61/812,374, filed on Apr. 16, 2013.

(51) Int. Cl. G10L 25/15

(52) U.S. Cl. CPC G10L 25/15
USPC 704/209

(57) ABSTRACT

Formant frequencies in a voiced speech signal are detected by filtering the speech signal into multiple frequency channels, determining whether each of the frequency channels meets an energy criterion, and determining minima in envelope fluctuations. The identified formant frequencies can then be enhanced by identifying and amplifying the harmonic of the fundamental frequency (F0) closest to the formant frequency.

### CROSS-REFERENCE TO RELATED APPLICATIONS

This application claims priority to U.S. Provisional Patent Application Ser. No. 61/812,374, filed on Apr. 16, 2013 and entitled “A Method for Detecting and Identifying Formant Frequencies in Voiced Speech,” the entire disclosure of which is incorporated herein by reference.

### BACKGROUND

The present invention relates to methods and systems for a signal-processing strategy to enhance speech for listeners with hearing loss and, more specifically, to methods and systems for enhancing vowel perception using speech analysis and formant enhancement.

Speech sounds are commonly classified into two major categories: vowels and consonants. Vowels are typically associated with higher energy and stronger periodicity. The relative importance of vowels and consonants in speech perception has been the topic of multiple studies. In studies using spoken sentences in the presence of background noise, vowels have been shown to play a more important role in word recognition than consonants. In the presence of noise, vowels carry more speech information, possibly because formant cues are robust even in noise.

Formant frequencies correspond to peaks in the short-time energy spectra of voiced sounds, arising due to the resonances of the vocal tract. Formants are one of the major cues in vowel perception, along with other factors such as spectral shape and formant ratio. Multi-dimensional analysis of the perceptual vowel space has ascertained that the two dimensions that account for the most variance in the perceptual space correspond to the first two formant frequencies.

Sensorineural hearing loss, however, results in broader tuning in the inner ear and thus distorts the patterns of modulations across frequency channels. As a result, there is a need to improve vowel discrimination in listeners with hearing loss, particularly by restoring cues that are important for formant encoding, thereby ameliorating at least some of the sensorineural hearing loss.

### BRIEF SUMMARY

Described herein are systems and methods for a signal-processing strategy to detect formant frequencies and to enhance speech for both listeners with hearing loss and for listeners with normal hearing in the presence of noise. Sensorineural hearing loss results in broader tuning in the inner ear, and thus distorts the patterns of modulations across frequency channels. One goal for speech enhancement is therefore to restore the representation of one or more formants. In particular, the goal is to restore the reduction in modulations in the channels near formants, while maintaining the modulations in intermediate channels. This restoration can be accomplished by identifying the formant frequencies and then amplifying the harmonic frequency closest to each formant, or pair of closely spaced formants, in order to saturate these channels, which reduces the fluctuations in those responses. Intermediate frequency channels can also be amplified, to a lesser extent, to ensure audibility, and thus to guarantee that there is sufficient contrast in the fluctuations between the channels that are strongly modulated and those that are not.

According to an aspect, a method for processing a voiced speech signal comprises the steps of: (i) receiving a signal comprising voiced speech; (ii) dividing the received speech signal into a plurality of frames; (iii) identifying which of said plurality of frames comprises voiced speech; (iv) identifying a fundamental frequency (F0) for each of the identified frames; (v) applying an auditory filter bank to the identified frames to produce a plurality of frequency channels; (vi) scaling each of said plurality of frequency channels using a saturating nonlinearity; (vii) determining an envelope value for each of the scaled plurality of frequency channels; (viii) filtering the envelopes of the plurality of frequency channels using the determined envelope filters; (ix) determining formant frequencies from the filtered plurality of frequency channels, comprising the step determining whether each of the filtered plurality of frequency channels has an energy level above a predetermined energy criterion and a relatively low amount of modulation at F0; (x) identifying, for each identified formant frequency, a harmonic of F0 closest to the identified formant frequency; and (xi) amplifying the identified harmonic using a narrowband filter.

According to an embodiment, the method further includes the step of normalizing a sound level of the received voiced speech signal.

According to an embodiment, the step of applying an auditory filter bank to the received speech signal comprises the step of decomposing each of said identified frames into two or more bandpass channels using a set of bandpass filters.

According to an embodiment, the saturating nonlinearity is a smoothly saturating function such as a hyperbolic tangent or a Boltzmann function.

According to an embodiment, the step of filtering the plurality of frequency channels using the determined envelope values comprises passing each of the determined envelope values through a narrow bandpass filter.

According to an embodiment, the step of filtering the plurality of frequency channels using the determined envelope values comprises passing each of the determined envelope values through a modulation filter.

According to an embodiment, the step of identifying a harmonic of F0 comprises finding an integer multiple of F0 closest to identified formant frequency.

According to an aspect, a system for processing a voiced speech signal includes: (i) a signal processing module configured to receive a signal comprising voiced speech and divide the received speech signal into a plurality of frames; (ii) a fundamental frequency (F0) module configured to identify which of said plurality of frames comprises voiced speech, and identify an F0 for each of the identified frames; (iii) a formant estimation module configured to apply an auditory filter bank to the identified frames to produce a plurality of frequency channels, scale each of said plurality of frequency channels using a saturating nonlinearity, determine an envelope value for each of the scaled plurality of frequency channels, filter the plurality of envelopes of the frequency channels using the determined envelope filters, and determine formant frequencies from the filtered plurality of frequency channels comprising the step of determining whether each of the filtered plurality of frequency channels has an energy level above a predetermined energy criterion and a relatively low amount of modulation at F0; and (iv) a formant enhancement module configured to receive the determined formant frequencies, identify for each determined formant frequency a harmonic of F0 closest to the identified formant frequency, and amplify the identified harmonic using a narrowband filter.

According to an embodiment, the signal processing module is further configured to normalize a sound level of the received voiced speech signal.

According to an embodiment, applying an auditory filter bank to the received speech signal comprises decomposing each of said identified frames into two or more bandpass channels using a set of bandpass filters.

According to an embodiment, the saturating nonlinearity is a smoothly saturating function such as a hyperbolic tangent or a Boltzmann function.

According to an embodiment, filtering the plurality of frequency channels using the determined envelope values comprises passing each of the determined envelope values through a narrow bandpass filter or a modulation filter.

According to an embodiment, identifying a harmonic of F0 comprises finding an integer multiple of F0 closest to identified formant frequency.

According to an aspect, a method for processing a voiced speech signal comprises the steps of: (i) receiving a signal comprising voiced speech; (ii) normalizing a sound level of the received voiced speech signal; (iii) dividing the received speech signal into a plurality of frames; (iv) identifying which of said plurality of frames comprises voiced speech; (v) identifying a fundamental frequency (F0) for each of the identified frames; (vi) decomposing each of said identified frames into a plurality of frequency channels using a set of bandpass filters; (vii) scaling each of said plurality of frequency channels using a saturating nonlinearity; (viii) determining an envelope value for each of the scaled plurality of frequency channels; (ix) filtering the envelopes of the plurality of frequency channels using the determined envelope values by passing each of the determined envelope values through a modulation filter or a narrow bandpass filter; (x) determining formant frequencies from the filtered plurality of frequency channels, comprising the step determining whether each of the filtered plurality of frequency channels has an energy level above a predetermined energy criterion and a relatively low amount of envelope modulation at F0; (xi) identifying, for each identified formant frequency, a harmonic of F0 closest to the identified formant frequency, wherein said harmonic is an integer multiple of F0; and (xii) amplifying the identified harmonic using a narrowband filter.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic diagram of a method for the detection of one or more formant frequencies in voiced speech according to an embodiment;

FIG. 2 is a schematic diagram of a vowel enhancement system according to an embodiment, in which solid arrows indicate flow of the speech signal and dashed arrows indicate flow of calculated parameters such as pitch and formants;

FIG. 3 is a diagram representing autocorrelation functions (ACF) of two 32 ms segments in which the horizontal axis represents the lag or time delay (δ) and the vertical axis represents the value of the ACF (cᵣᵣ(δ)), with the highest peak from this region being the candidate pitch period. In FIG. 3(a) the ACF of a 32 ms segment of the vowel portion of the word ‘had’ is shown, where the time lag corresponding to the maximum value of the ACF (6P) is the pitch period of this vowel (about 6.625 ms), which corresponds to a pitch (F0) of about 150.9 Hz. In FIG. 3(b) the ACF of a 32 ms segment of the leading consonant h of the word ‘had’ is shown;

FIG. 4 is a schematic diagram of formant estimation according to an embodiment, in which solid arrows represent flow of the speech signal, while dashed arrows represent flow of parameters such as pitch and formant estimates;

FIG. 5 is a series of graphs according to an embodiment, in which 5(a) is the spectrum of a sound source with F0=100 Hz; 5(b) is the gain versus frequency plot of a vocal-tract filter with three spectral peaks; and 5(c) is the spectrum of the resultant sound;

FIG. 6 is a series of graphs of: 6(a) waveforms of two bandpass channels; and 6(b) the corresponding outputs of the saturating nonlinearity for both waveforms;

FIG. 7 is a schematic diagram of formant estimation according to an embodiment; and

FIG. 8 is a schematic diagram of a method or system for the detection and enhancement of one or more formant frequencies in voiced speech according to an embodiment.

### DETAILED DESCRIPTION

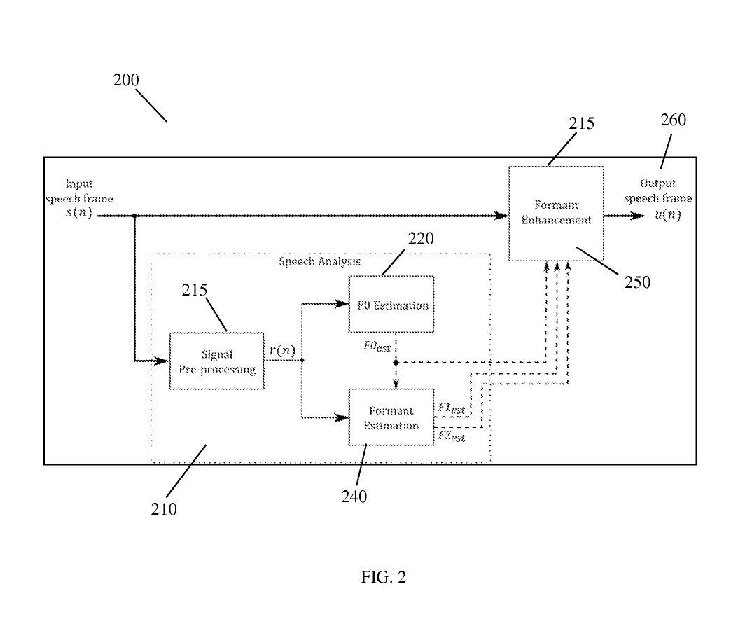

Described herein are methods and systems for enhancing vowel perception using speech analysis and formant enhancement. Depicted in FIG. 2, for example, is a general schematic of a vowel-enhancement method or system 200 having a speech analysis stage or module 210 and a formant enhancement stage or module 215. As described below in greater detail, the speech analysis stage or module performs various pre-processing tasks and estimates the fundamental frequency (F0) and the first two formants (F1 and F2) of the speech frame. The formant enhancement stage or module then amplifies the harmonic closest to each formant estimate, thereby increasing its dominance.

Speech Analysis And Formant Detection

According to an embodiment, the method or module utilized to detect formants in voiced speech (including vowels) is based on properties of auditory neurons in the brain. The method can take advantage of the profile of pitch-related modulations (or fluctuations) across the responses of different frequency channels thusly: (i) formant frequencies, which are the frequencies associated with the resonant peaks of the vocal tract, are associated with strong sustained activity that has relatively weak temporal modulations; and (ii) auditory channels tuned to frequencies in between formant frequencies have strongly modulated responses. Taking advantage of this pattern provides a strategy for detecting and identifying formant frequencies. Notably, the strategy is robust across a wide range of sound levels and in the presence of background noise.

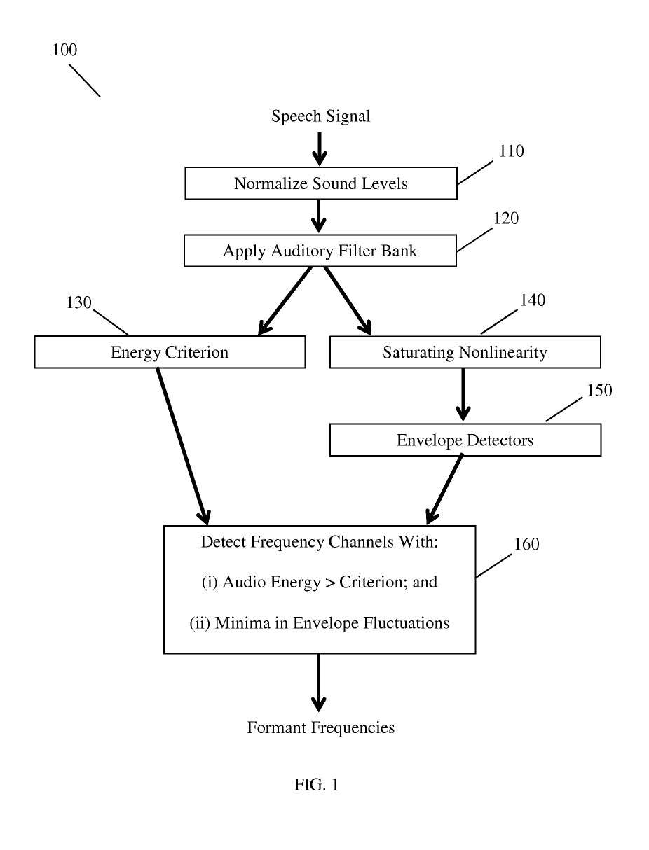

Depicted in FIG. 1 is a schematic of one embodiment of a method 100 for processing a signal to detect one or more formants. At step 110, the sound levels in the speech signal input are optionally normalized. Level normalization allows, for example, for simplification of energy criterion and saturating nonlinearities.

At step 120, the signal undergoes auditory filtering. According to an embodiment, the signal is decomposed into multiple bandpass channels by an auditory filterbank comprising a set of bandpass filters with center frequencies based on the equivalent rectangular bandwidth (ERB) scale. An auditory filterbank reflects properties of the basilar membrane such as the logarithmic physical mapping of frequencies, and frequency-dependent bandwidths. These filterbanks consist of approximately logarithmically-spaced filters with bandwidths increasing with center frequency. According to an embodiment, the auditory filterbank can be implemented with any set of narrowband filters (e.g. gammatone, rectangular) and parameters can be chosen based on standard auditory bandwidths (e.g., ERBs).

At step 130, the system or method determines whether each of the channels from step 120 meet an energy criterion and an envelope fluctuation criterion. Envelope fluctuation minima in a channel or signal could be due to low energy. In order to eliminate such spurious minima, an energy criterion is imposed. According to an embodiment, root-mean-square (RMS) values of the output of the saturating nonlinearity of each channel is utilized as the energy criterion. The energy criterion value can vary with audio frequency, based on the typical drop in energy of harmonics across the speech spectrum (e.g., −9 dB/decade).

At step 140, saturating nonlinearities in each of the frequency channels are applied. According to an embodiment, saturating nonlinearities can be any smoothly saturating function, such as a hyperbolic tangent or Boltzmann function. Thus, each filter channel can be scaled on a sample-by-sample basis using a saturating nonlinearity. The nonlinearity serves to, for example, replicate the level-dependent discharge-rate saturation characteristics of AN fibers. Saturation is critical for the enhancement algorithm as it influences the degree of amplitude modulation within the channel.

At step 150, envelope fluctuations in each of the frequency channels—after application of the saturating nonlinearities—are detected. According to an embodiment, the envelope detector can be a Hilbert-transform or a half-or full-wave rectifier and low-pass filter followed by either a modulation filter tuned to the pitch of the input speech sound (controlled by a parallel pitch (FO) identification procedure) or by a low-pass envelope filter. Envelope fluctuations are detected in order to remove the influence of overall energy differences between channel envelopes before calculation of the pitch-related channel strengths in following steps.

At step 160, candidate formant channels are selected by determining whether each of the frequency channels includes a formant frequency in accordance with: (i) whether each of the frequency channels has an audio energy above the energy criterion; and (ii) minima in envelope fluctuations.

Frequency channels near formants will be saturated and will have relatively small envelope fluctuations. Frequency channels away from formant frequencies will have low-frequency fluctuations related to the pitch (or distance between harmonics that pass through the filter). Formants are identified as channels that have audio energy above a criterion level, but relatively low envelope fluctuations.

This method of speech analysis can be used, for example, in automatic speech recognition systems, as detecting and identifying the first (lowest) two formant frequencies is the critical step for vowel identification. The method would be, for example, a component of a system to reinforce formant frequencies in a signal-processing strategy to enhance vowels for listeners with hearing loss. Importantly, the method takes advantage of the features of responses of auditory neurons in the central nervous system, which respond selectively to low-frequency envelope fluctuations in their inputs. These fluctuations vary systematically across frequency channels in a manner that can be used to detect formants. This detection strategy is robust over a wide range of sound levels and in the presence of background noise, unlike existing strategies.

According to one embodiment, speech analysis stage or module 210 is a processor, computer module, program code, or other structural component capable of processing a speech signal. Again referring now to FIG. 2, a flow chart illustrating a method 200 for analyzing a speech signal is disclosed. In step 210, a speech signal is presented to speech analysis module 210. The speech signal can already be digitized and stored elsewhere prior to delivery, or can be digitized from an analog source as it is fed into speech analysis module 210. For example, the speech signal can be a live analog signal that is transferred to a digital signal and fed directly into speech analysis module 110 for processing. Alternatively, the speech signal can be a digital signal that was recorded or otherwise created days, months, or even years before processing.

At step 220 of method 200 in FIG. 2, the digital signal is processed by speech analysis module 210, or another module responsible for processing the signal prior to analysis by speech analysis module 110. According to one embodiment, the signal is decomposed into multiple bandpass channels by an auditory filterbank comprising a set of bandpass filters with center frequencies based on the equivalent rectangular bandwidth (ERB) scale.

### EXAMPLE

### Signal Pre-Processing

According to a MATLAB-based implementation, an incoming speech signal was divided into 32-ms long frames, with 50% overlap across successive frames. For the sampling rate of 8000 Hz, this translated into a frame length of 256 samples. First, DC offset removal was performed on the current frame, followed by windowing:

$$\begin{matrix}{s}_{zm} ( n ) = s ( n ) - \overline{s} ( n ) , for 0 \leq n \leq N - 1 , n ∈ ℤ & ( 1 ) \\ w ( n ) = 0.5 ( 1 - cos \frac{2 π n}{N - 1} ) & ( 2 ) \\ {s}_{w} ( n ) = {s}_{zm} ( n ) w ( n ) & ( 3 )\end{matrix}$$

where s(n) is a sequence representing the current input frame; n is an index that takes integer values between 0 and N−1; N is the frame length (in number of samples); S̅(n) is the mean of the sequence s(n) over the frame; s_{zm}(n) is the zero-mean sequence obtained after DC removal; and s_{w}(n) is the sequence obtained after windowing s_{zm}(n) using a Hanning window w(n) of length N.

Next, a sequence r(n) was obtained by normalizing s_{w}(n) such that its root-mean-square (RMS) amplitude was unity. This normalization was needed because the input of the saturating nonlinearity must have sufficiently high energy in order to transform all frames to the same output range.

At step 220 (F0 estimation) of method 200 in FIG. 2, voiced regions or segments of speech and pitch (F0) are identified or detected. According to an embodiment, voiced regions of speech (e.g., vowels) are associated with a pitch and a set of formants. The F0 estimation stage identifies the current frame as being either voiced or unvoiced, and estimates F0.

### EXAMPLE

### F0 Estimation

Many F0 detection algorithms employ methods such as autocorrelation, average magnitude difference function, zero-crossing rates, etc., to estimate the principal period of a speech frame. In this example, a MATLAB implementation of an autocorrelation-based pitch extraction algorithm was used from the Speech and Audio Processing Toolbox.

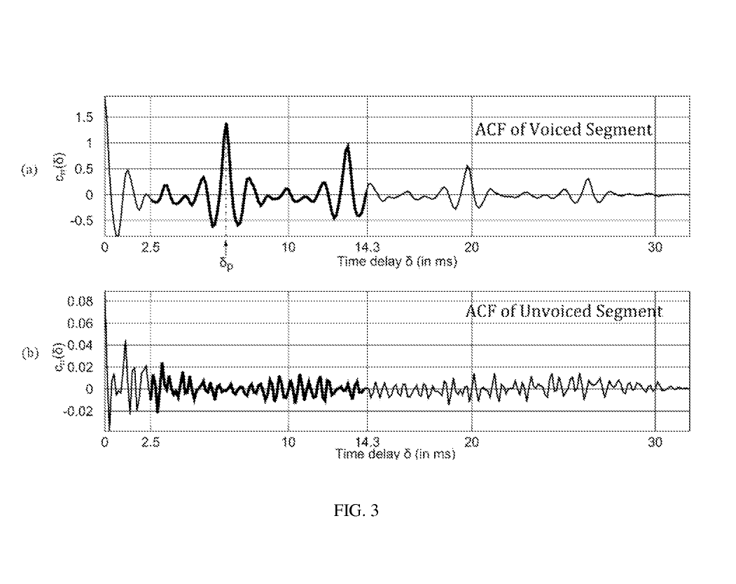

Typical autocorrelation-based pitch extraction algorithms compute a running autocorrelation function (ACF) for each frame within a range of time delays. The frame's periodicity is indicated by the peaks in cᵣᵣ(δ) and the time delays (δ) corresponding to these peaks indicate the possible pitch periods (see, e.g., FIG. 3). The range of possible pitch periods was limited to 2.5 ms-14.3 ms, corresponding to a plausible voice pitch range from 70 Hz to 400 Hz. Another modification was made to the ACF calculation in order to reduce the tapering off of the function due to decreasing overlap lengths at large values of δ. This tapering effect was reduced by using a variation of the ACF in which the sum is divided by the length of overlap (N−δ):

$${c}_{rr} ( δ ) = ( {\sum }_{n = 0}^{N - 1 - δ} r ( n ) r ( n + δ ) ) / ( N - δ ) \qquad ( 4 )$$

where cᵣᵣ(δ) is the autocorrelation sequence of the current frame r(n); δ is the lag or delay (in samples); and N is the frame length (in samples).

The distinction between frames of interest (voiced frames) and silent or unvoiced frames was based on a clarity metric. If for a particular frame, cᵣᵣ(δ) was found to be maximum at δₚ, then clarity of that frame was defined as the ratio cᵣᵣ(δₚ)/cᵣᵣ(0). High clarity indicates frames with voiced speech whereas low clarity indicates frames with unvoiced speech or silence. A frame's F0 estimate (F0ₑₛₜ) was set to 0 if its clarity was below a threshold. In the formant-tracking stage, frames with F0ₑₛₜ equal to zero are considered to be unvoiced frames. A suitable threshold value for clarity for speech sentences in quiet was empirically found to be 0.50.

At step 240 (Formant Estimation) of method 200 in FIG. 2, formants are estimated for the current frame using input from the signal pre-processing step and the F0ₑₛₜ. Although FIG. 2 depicts two formants (F1ₑₛₜ and F2ₑₛₜ), many formants can be detected. According to an embodiment, candidate formant channels are selected by determining whether each of the frequency channels includes a formant frequency in accordance with: (i) whether each of the frequency channels has an audio energy above the energy criterion; and (ii) minima in envelope fluctuations.

### EXAMPLE

### Formant Estimation

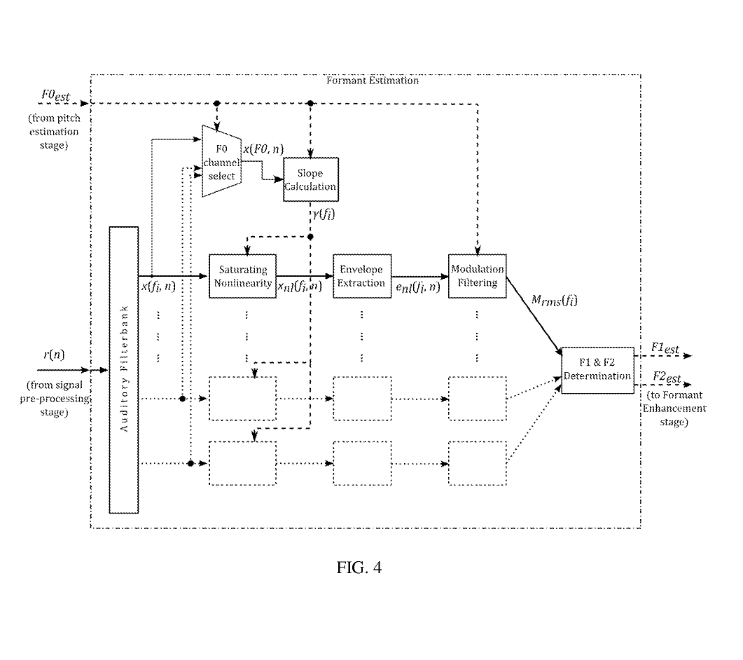

In this example, the first two formants are estimated for the current voiced frame. Formant-tracking is not performed for frames with clarity below threshold. This stage replicates salient aspects of physiological auditory processing, such as the bandpass filtering of the auditory periphery, saturated discharge-rates of AN fibers, and the tuning of midbrain neurons to F0-related modulations. Substages within this formant estimation stage are described in reference to FIG. 4.

Auditory Filtering

The speech frame, r(n), is decomposed into multiple bandpass channels, x(f, n), by an auditory filterbank comprising a set of bandpass filters with center frequencies based on the equivalent rectangular bandwidth (ERB) scale. An auditory filterbank reflects properties of the basilar membrane such as the logarithmic physical mapping of frequencies, and frequency-dependent bandwidths. These filterbanks consist of approximately logarithmically-spaced filters with bandwidths increasing with center frequency. The center frequencies of the 44-channel filterbank used here ranged from 70 Hz to 3700 Hz. The lower limit of this frequency range was chosen to match the lower limit of the plausible range of human voice pitch.

Saturating Non-Linearity

Each filter channel of the current frame is scaled on a sample-by-sample basis using a saturating nonlinearity. The nonlinearity serves to replicate the level-dependent discharge-rate saturation characteristics of AN fibers. Saturation is critical for the enhancement algorithm as it influences the degree of amplitude modulation within the channel. The sigmoid curve used was a Boltzmann function of the form:

$${x}_{nl} ( f , n ) = \frac{{A}_{1} - {A}_{2}}{1 + {e}^{x ( f , n ) γ ( f )}} + {A}_{2} \qquad ( 5 )$$

where xₙₗ(∫, n) is the output of the nonlinearity for the bandpass-filtered channel x(∫, n) with center frequency f; A₁ and A₂ are the lower and upper limits of the nonlinearity and were fixed at −1 and 1 respectively; γ(f) is the slope of the sigmoid curve and depends on the center frequency of the current channel γ(f) was determined using a frequency-dependent source spectrum threshold function based on a well-known model of speech production, described next.

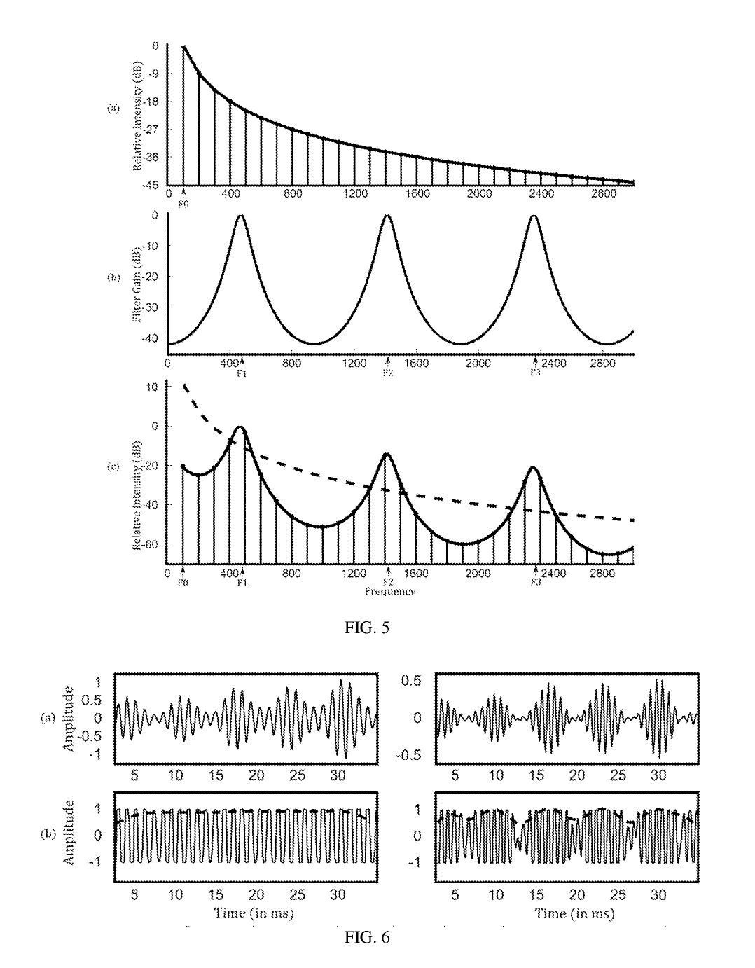

According to a Source-Filter Model of Speech Production, speech sounds are the result of a source of sound energy (e.g., the larynx) and a vocal tract filter. The filter's transfer function is shaped by resonances of the vocal tract. In the case of voiced sounds (FIG. 5a), the magnitude spectrum of the sound source (known as source spectrum) contains peaks at F0 and at its harmonics, with a downward slope between 8 and 16 dB/octave. This monotonically decreasing source spectrum is then shaped by the transfer function of the vocal tract filter (FIG. 5b), resulting in the spectral peaks known as formants. Note that F0 is attenuated (FIG. 5c) by the vocal tract filter and is usually several dB less than the level at F1.

For a frame with index c, the slope of the nonlinearity (γ_{c}(f)) was calculated such that its output had an overall flat envelope for channels near formants, similar to the output discharge-rates of AN fibers tuned near formants. The source spectrum threshold function (S_{c}(f)) is a nonlinear function of frequency and decreases monotonically, similar to the peaks of the source spectrum in the source-filter model. S_{c}(f) was defined as:

$${S}_{c} ( f ) = \frac{{10}^{\frac{- m \cdot lo {g}_{2} ( f / F 0 ) - k}{20}}}{{x}_{rm s} ( F 0 )} \qquad ( 6 )$$

where f is the center frequency of an auditory filter channel, and c is the index of the current frame; F0 is the voice pitch of the current frame; xᵣₘₛ(F0) is the RMS value of the filter output whose center frequency is closest to F0ₑₛₜ (denoted as F0 Channel Select in FIG. 4); m is the source spectrum slope (in dB/octave); and k (in dB) is a factor employed to partially offset the attenuation at F0 due to the vocal-tract filter. Suitable values of m and k were empirically determined (−9 dB/octave and 6 dB respectively) such that the RMS values of channels near formants remain above the source spectrum threshold value (FIG. 5c), and thus result in those channels being saturated to a higher degree by the sigmoid function than channels away from formants (FIG. 6).

The frequency-dependent slope γ_{c}(f) of the nonlinearity was obtained using the following equation:

γ_{c}(f)=l·S_{c}(f) (7)

where l is a constant that controls the influence of S_{F}(f) on the saturating nonlinearity. Decreasing l results in more aggressive saturation. In the current implementation, the value of l was set to 1.

Envelope Extraction

In this stage, the envelope of each channel was obtained by removing the fine structure of the output of the nonlinearity (xₙₗ(f, n)) with a full-wave rectification followed by low-pass filtering with a cutoff frequency of 400 Hz with a 50^{th} order FIR filter. The signal eₙₗ(f, n) was then obtained by performing DC offset removal on the envelope of the signal. This was done in order to remove the influence of overall energy differences between channel envelopes before calculation of the pitch-related channel strengths in the next stage.

Modulation Filtering

Next, modulation filtering was performed to simulate the modulation-tuning of auditory midbrain neurons. Each channel envelope was passed through a narrow bandpass filter centered at F0 to extract the signal components having frequency near F0. Then, in order to quantify the relative strengths of F0-related modulations across all channels, a measure Mᵣₘₛ(f) was obtained by calculating the RMS of each channel envelope's F0 component. Mᵣₘₛ(f) is thus a sequence indexed on the center frequency of each channel of the auditory filterbank. Due to the higher degree of saturation near formants, frequencies corresponding to the minima of Mᵣₘₛ(f) were closest to the actual formants.

F1/F2 Determination

Next, Mᵣₘₛ(f) was smoothed using a 5-point symmetric, exponentially weighted smoothing kernel prior to locating its local minima. Center frequencies corresponding to the minima were selected as candidate formants and sorted in ascending order of frequency. In addition to saturation of channel outputs, minima in Mᵣₘₛ(f) could also be due to very low energy in a particular channel. In order to eliminate such spurious minima, an energy criterion was imposed using the RMS values of the output of the saturating nonlinearity of each channel. A channel having an RMS value below the average of those RMS values was rejected as a possible formant channel. From the remaining values in Mᵣₘₛ(f), the formant estimates F1ₑₛₜ and F2ₑₛₜ were obtained by choosing center frequencies corresponding to the first two values. The formant estimates were thus limited to center frequencies of auditory filters.

Enhancement of Detected Formants

According to an embodiment, the method or module utilizes the estimate of the fundamental frequency of the identified formants and amplifies the harmonic closest to each formant estimate, thereby increasing its dominance. According to one embodiment, the harmonic closest each formant is amplified using a narrowband filter that tracks harmonic frequency (with standard overlap and add strategies to avoid transients). Other harmonics can be amplified, as necessary for an individual listener, to ensure audibility of the harmonic overall structure, and thus to provide contrast from saturated channels created by the enhanced formant.

Accordingly, at step 250 of method 200 in FIG. 2, F0ₑₛₜ and FXₑₛₜ (where F0ₑₛₜ represents one or more estimated formants) are transferred to the formant enhancement stage or module and utilized to enhance the estimated formants according to one or more methods or systems described herein.

### EXAMPLE

### Formant Enhancement

This example utilizes F0ₑₛₜ, F1ₑₛₜ, and F2ₑₛₜ provided by the speech analysis stage to boost the dominance of a single harmonic near F1 and F2. According to the midbrain vowel-coding hypothesis, deterioration of formant-encoding at the level of auditory midbrain neurons can be attributed to broadened frequency selectivity properties of an impaired auditory periphery, resulting in a reduction in the dominance of the harmonic closest to formants. As a logical extension, artificially increasing the dominance of a harmonic was hypothesized to counter this phenomenon and lead to AN discharge characteristics more similar to those in the normal ear.

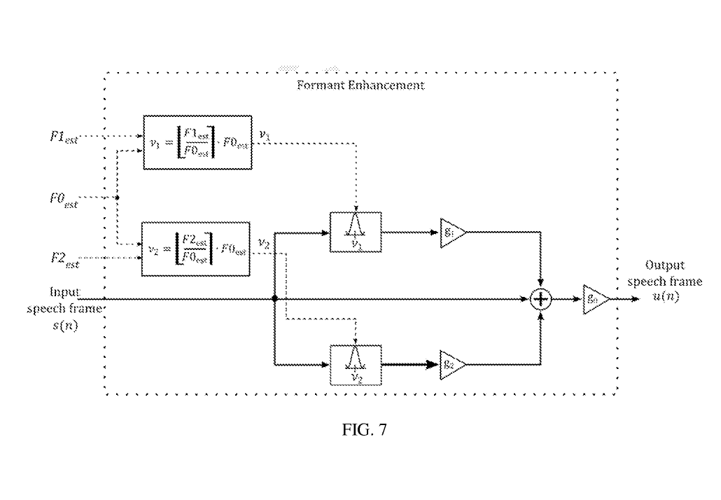

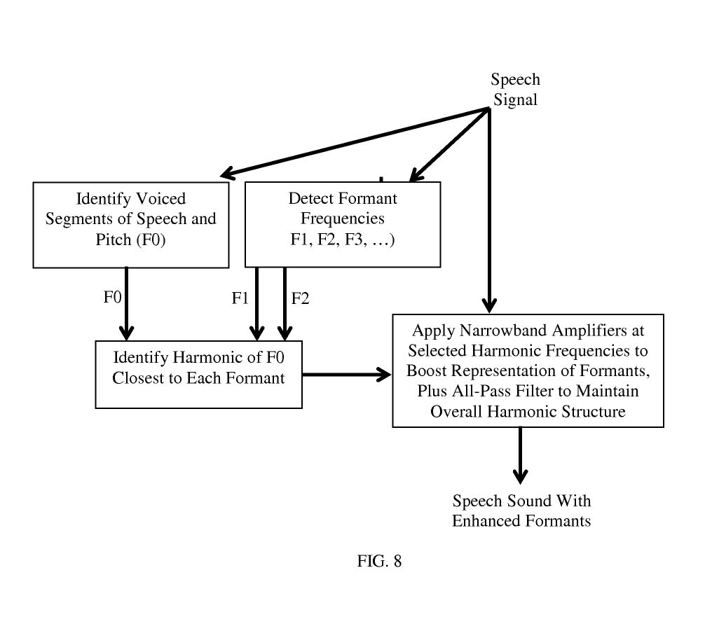

As shown in FIG. 7, first, the frequencies ν₁ and ν₂ of two harmonics were calculated by finding the integer multiples of F0ₑₛₜ closest to F1ₑₛₜ and F2ₑₛₜ. If any formant estimate was found to be equidistant from two adjacent harmonics, the lower harmonic was chosen.

Next, two linear-phase narrowband finite impulse response (FIR) bandpass filters, centered at ν₁ and ν₂ respectively, having passband gains of g₁ and g₂, amplified the respective harmonics in the current speech frame, s(n). In the current implementation, an FIR filter of order 300 was generated using the Kaiser Window method of FIR filter design, using a bandwidth of 50 Hz and a stopband attenuation of 25 dB. A gain g₀ was then applied to the summation in order to account for elevated thresholds in listeners with hearing loss. Appropriate values of these gains would be determined empirically for each subject. The gains g₁ and g₂ would be fixed across time, and selected based on responses to a range of vowel sounds.

At step 260 of method 200 in FIG. 2, speech sound with enhanced formants is output from the system. This speech sound can be utilized for a variety of downstream applications.

### EXAMPLE

Provided is an example of an application of the speech enhancement method or system described herein. This example is provided only to further explain the invention, and is not intended to limit the scope of the claims or the invention in any way.

In this example, the speech enhancement method is used for listeners with hearing loss. The strategy aims to improve vowel discrimination in listeners with hearing loss by restoring cues that are important for formant encoding at the level of the auditory midbrain. The signal-processing system tracks time-varying formants in voiced segments of the input and increases the dominance of a single harmonic near each formant in order to decrease F0-related fluctuations in that frequency channel.

Many midbrain neurons are not only tuned to the energy within a narrow range around their best audio frequency or best frequency (BF), but are also tuned to the frequency of amplitude modulations. That is, a midbrain neuron responds maximally to energy near its BF if the energy modulation rate is close to the neuron's best modulation frequency (BMF). Many modulation-tuned midbrain neurons in a wide range of species have BMFs between 10 and 300 Hz, which includes the range of voice pitch. According to the midbrain vowel-coding hypothesis, in addition to energy, the pitch-dependent strength of fluctuations in AN discharge-rates is significant in shaping midbrain neural responses. Also, as a consequence, a midbrain neuron with a BMF close to F0, exhibits lowered response rates if its BF is close to a formant and exhibits elevated response rates if its BF is between formants. The midbrain vowel-coding hypothesis is robust over a wide range of sound levels and tapers off for sound levels above 80 dB SPL. This neural coding strategy deteriorates for noise interference at signal-to-noise ratios consistent with listeners with normal hearing.

A non real-time implementation of the system with tunable parameters was developed in MATLAB to test the ability of the method or system described herein to guide a novel formant-tracking method and to enhance the discrimination of vowels in listeners with hearing loss.

The three parameters of the saturating non-linearity in the formant-tracking subsystem, k, l and m, were deduced empirically using a speech dataset consisting of four vowels: /ae/ (“had”), /iy/ (“heed”), /uw/ (“who'd”) and /uh/ (“hud”) from one male speaker. Keeping these parameters fixed, the formant-tracking subsystem was then evaluated using a vowel database containing 12 English vowels spoken by 139 speakers consisting of 93 adults (male and female speakers) and 46 children (27 boys and 19 girls). The database consists of single-vowel samples of the form “hVd”, where V is an English vowel. This annotated database contains acoustic measurements of each vowel sample including vowel durations, start and stop-times, and pitch and formant values at the middle of the vowel duration.

In order to compare estimates of the formant-tracking subsystem to the database formant values, the vowel portion from each sample was extracted using the vowel start and end times provided by the database. This segment was then downsampled to 8000 Hz and was passed through the pitch tracking and formant-tracking subsystems. Next, F0ₑₛₜ, F1ₑₛₜ, and F2ₑₛₜ of the center-most frame were selected. The magnitude of the difference between each formant estimate and its corresponding known formant frequency from the database was normalized using the known F0 value. This measure of error gauges the deviation of the estimates in terms of number of harmonics, for example, values of this measure between 2 and −2 indicate that the formant estimate was correct within two harmonics. Vowel utterances for which the pitch tracking system wholly failed to identify the center-most frame as a voiced frame were not shown. Approximately 5.42% of the vowel utterances in the database were discarded for this reason. The results of the objective tests demonstrated that the formant-tracking strategy is likely to generalize well over multiple speakers. The algorithm performed more poorly for F2 estimates than for F1 estimates, and this trend was seen across speaker types and vowels. The majority of F1 estimation errors are below one harmonic, whereas they are below five harmonics for F2.

Comparison of results for all 12 vowels indicates that the formant-tracking strategy generalizes well over many vowels, including those not used for determination of the system parameters. Further fine tuning of the system parameters can be performed in order to achieve higher accuracy for F2 estimates. Many formant-tracking techniques in the literature include gender detection modules to apply different processing or different parameters for male and female speakers. However, the performance of the formant tracking subsystem yielded similar results for adult speakers of both genders, in addition to children. Objective evaluation tests for vowels spoken in noise would reveal the suitability of this strategy to real-world sounds.

In addition to frequencies corresponding to channels close to formants and those with low energy, minima were also found in channels in the neighborhood of those close to formants. Many of these minima occur at channels corresponding to the first few harmonics of the speech sample and are more defined for speakers with high voice pitch (women and children). These contribute to most of the F1 estimation errors and some of the F2 under-estimation errors where a minima at a frequency close to F1 (but higher in frequency) is selected as F2. Problems due to these smaller minima can be reduced, for example, with a more aggressive smoothing function and better minima-calculation techniques.

Vowels having F1 and F2 close to each other (e.g. /aw/) are more prone to F1 and F2 overestimation errors due to the merging of F1/F2 minima due to smoothing. In these cases, F3 is misidentified as F2. This case, combined with multiple minima near formants presents the tradeoff that the smoothing operation needs to overcome. Aggressive smoothing reduces overall F1/F2 estimation errors but would result in insufficient separation of F1/F2 minima in vowels with close F1/F2 frequencies. Another factor for F1/F2 estimation errors is that in some cases, _{Mrms(f)} exhibits broad and flat regions of minima with multiple undulations within the region. This causes one of those undulations to be misidentified as a formant.

In this example, Mᵣₘₛ(f) was smoothed before minima calculation. According to an embodiment, smoothing is essential for minima calculation because Mᵣₘₛ(f) may contain similar values at points adjacent to the center frequency corresponding to a formant. The role of smoothing may be a contributing factor for this phenomenon due to logarithmic spacing between each center frequency. Instead of symmetric smoothing weights, asymmetric weights may be required to account for the unequal distance between successive center frequencies. Asymmetric exponential smoothing weights were found to improve this problem in a few initial test cases, but a set of weights that generalized well could not be found trivially. For minima calculation, simple derivative-based minima techniques fail to apply due to the small number of points (one point for each center frequency of the auditory filterbank) and due to unequal spacing of the independent variable (center frequency). In this example, minima calculation in the implementation was done using a built-in MATLAB function (findpeaks). To reduce errors due to low harmonics causing minima, the strongest minima is chosen from those that are within a spectral distance of 1.5 times the value of F0ₑₛₜ from each other.

Formant estimation in vowels with low F1 frequencies (e.g., /ee/) can show large F1 over-estimation errors due to the effect of the slope offset factor (k) on low-frequency channels. When a formant is close to the pitch, the source spectrum threshold function is likely to remain higher than the energy at F1 because the difference in energy between F0 and F1 is lower than k. This leads to insufficient saturation of channels near F1 and thus, in those cases, the formant might be ignored by the algorithm.

According to the example, the pitch extraction subsystem is crucial for the performance of the formant-tracking subsystem and the overall vowel-enhancement system. The accuracy of F0ₑₛₜ is important for the saturating nonlinearity's operation due to the dependence of its source spectrum threshold function on the energy near the voice pitch. Additionally, the formant-tracking subsystem directly uses the distribution of the strength of F0-related fluctuations at the output of the modulation filters in the formant-tracking subsystem, which underscores the importance for accurate F0 estimation. A drawback of the simple variant of the autocorrelation function used is that peaks corresponding to an integer multiple of the true pitch period may sometimes be the local maximum, resulting in F0ₑₛₜ erroneously being calculated as half of the true pitch. This problem (called “pitch-halving”) is common in computationally simple pitch extraction algorithms and can be reduced by either preserving the tapering effect observed in basic autocorrelation function, or more robustly, by detecting these errors through additional logic in the pitch extraction algorithm.

Another major purpose of the pitch extraction subsystem was to identify voiced regions of continuous speech because the operations of formant-tracking and vowel-enhancement are carried out on only the voiced portions of speech. Detection of voiced speech in the current implementation is done on the basis of a measure called clarity—the relative strength of the autocorrelation function at the delay corresponding to the candidate pitch period to its value at zero delay. Frames having high values of this ratio were deemed to be voiced. A simple binary decision like clarity is, however, unable to fully generalize on a large range of real-world speech. These problems were also observed during preparation of preliminary test datasets consisting of English sentences spoken in quiet. Inaccuracies in voiced segment identification of some sentences were found and could be corrected by adjusting the clarity threshold of the pitch extraction algorithm. For robust pitch estimation and voiced region detection, other more reliable methods that satisfy computational constraints can be used instead.

According to this example, the primary role of the saturating nonlinearity in the formant-tracking subsystem is to exaggerate the difference in depth of amplitude modulation between filter channels. Thus, analogous to the outputs of modulation-tuned auditory midbrain neurons, simple modulation filtering of channel outputs results in low RMS values of channels near formants. Objective evaluation tests have shown that the operation of the nonlinearity is robust over multiple speakers and vowels. The system's performance is likely to degrade in the presence of additive noise modulated at frequencies close to voice pitch. In preliminary tests, the formant-tracking subsystem proved to be reasonably robust over other values of the source spectrum slope (m) in addition to −9 dB/octave. However, it has shown sensitivity to the slope offset parameter (k). Smaller values of this parameter led to a lack of contrast between modulation strengths across filter channel outputs, hence resulted in the loss of minima corresponding to formant frequencies. In addition, increasing the value of this parameter would result in an increase of F1 over-estimation errors in vowels with low F1 frequencies (e.g., /ee/) for reasons explained previously.

The purpose of the formant enhancement stage is to selectively boost single harmonics closest to F1ₑₛₜ and F2ₑₛₜ. The bandwidth of the FIR filters used was set to 50 Hz, however the most suitable value for this parameter will be known through subjective evaluation experiments. For the same gain, a larger bandwidth is likely to be perceived as louder and less tone-like. However, increasing the bandwidth beyond values close to F0 result in audible fluctuations near formant frequencies due to the increased interference from adjacent harmonics.

During preliminary testing, a subject with high frequency hearing loss was allowed to listen to a few sentences processed by the vowel-enhancement system in order to adjust the volume to a comfortable level. The subject was then presented with sentences at values of g₁ and g₂ spanning 0 dB to 21 dB and the range of acceptable gains was determined. For this particular subject, the preferred range was between 6 dB and 15 dB. The subject was then presented a wider range of sentences processed using these gain parameters. The subject described the processed sounds as being noticeably different compared to reference sentences (processed with zero gains) but acceptable and sharper for gains of 6 dB and 9 dB.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

A “module” or “component” as may be used can include, among other things, the identification of specific functionality represented by specific computer software code of a software program. A software program may contain code representing one or more modules, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Any flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for processing a voiced speech signal, the method comprising the steps of:
receiving a signal comprising voiced speech;
dividing the received speech signal into a plurality of frames;
identifying which of said plurality of frames comprises voiced speech;
identifying a fundamental frequency (F0) for each of the identified frames;
applying an auditory filter bank to the identified frames to produce a plurality of frequency channels;
scaling each of said plurality of frequency channels using a saturating nonlinearity;
determining an envelope value for each of the scaled plurality of frequency channels;
filtering the plurality of frequency channels using the determined envelope values;
determining a formant frequency for each of the filtered plurality of frequency channels, comprising the step determining whether each of the filtered plurality of frequency channels has an energy level above a predetermined energy criterion;
identifying, for each identified formant frequency, a harmonic of F0 closest to the identified formant frequency; and
amplifying the identified harmonic using a narrowband filter.

2. The method of claim 1, further comprising the step of normalizing a sound level of the received voiced speech signal.

3. The method of claim 1, wherein the step of applying an auditory filter bank to the received speech signal comprises the step of decomposing each of said identified frames into two or more bandpass channels using a set of bandpass filters.

4. The method of claim 1, wherein said saturating nonlinearity is a smoothly saturating function.

5. The method of claim 4, wherein said saturating nonlinearity is a hyperbolic tangent.

6. The method of claim 4, wherein said saturating nonlinearity is a Boltzmann function.

7. The method of claim 1, wherein the step of filtering the plurality of frequency channels using the determined envelope values comprises passing each of the determined envelope values through a narrow bandpass filter.

8. The method of claim 1, wherein the step of filtering the plurality of frequency channels using the determined envelope values comprises passing each of the determined envelope values through a modulation filter.

9. The method of claim 1, wherein the step of identifying a harmonic of F0 comprises finding an integer multiple of F0 closest to identified formant frequency.

10. A system for processing a voiced speech signal, the system comprising:
a signal processing module configured to receive a signal comprising voiced speech and divide the received speech signal into a plurality of frames;
a fundamental frequency (F0) module configured to identify which of said plurality of frames comprises voiced speech, and identify an F0 for each of the identified frames;
a formant estimation module configured to apply an auditory filter bank to the identified frames to produce a plurality of frequency channels, scale each of said plurality of frequency channels using a saturating nonlinearity, determine an envelope value for each of the scaled plurality of frequency channels, filter the plurality of frequency channels using the determined envelope values, and determine a formant frequency for each of the filtered plurality of frequency channels comprising the step of determining whether each of the filtered plurality of frequency channels has an energy level above a predetermined energy criterion; and
a formant enhancement module configured to receive the determined formant frequencies, identify for each determined formant frequency a harmonic of F0 closest to the identified formant frequency, and amplify the identified harmonic using a narrowband filter.

11. The system of claim 10, wherein the signal processing module is further configured to normalize a sound level of the received voiced speech signal.

12. The system of claim 10, wherein applying an auditory filter bank to the received speech signal comprises decomposing each of said identified frames into two or more bandpass channels using a set of bandpass filters.

13. The system of claim 10, wherein said saturating nonlinearity is a smoothly saturating function.

14. The system of claim 13, wherein said saturating nonlinearity is a hyperbolic tangent.

15. The system of claim 13, wherein said saturating nonlinearity is a Boltzmann function.

16. The system of claim 10, wherein filtering the plurality of frequency channels using the determined envelope values comprises passing each of the determined envelope values through a narrow bandpass filter.

17. The system of claim 10, wherein filtering the plurality of frequency channels using the determined envelope values comprises passing each of the determined envelope values through a modulation filter.

18. The system of claim 10, wherein identifying a harmonic of F0 comprises finding an integer multiple of F0 closest to identified formant frequency.

19. A method for processing a voiced speech signal, the method comprising the steps of:
receiving a signal comprising voiced speech;
normalizing a sound level of the received voiced speech signal;
dividing the received speech signal into a plurality of frames;
identifying which of said plurality of frames comprises voiced speech;
identifying a fundamental frequency (F0) for each of the identified frames;
decomposing each of said identified frames into a plurality of frequency channels using a set of bandpass filters;
scaling each of said plurality of frequency channels using a saturating nonlinearity;
determining an envelope value for each of the scaled plurality of frequency channels;
filtering the plurality of frequency channels using the determined envelope values by passing each of the determined envelope values through a modulation filter or a narrow bandpass filter;
determining a formant frequency for each of the filtered plurality of frequency channels, comprising the step determining whether each of the filtered plurality of frequency channels has an energy level above a predetermined energy criterion;
identifying, for each identified formant frequency, a harmonic of F0 closest to the identified formant frequency, wherein said harmonic is an integer multiple of F0; and
amplifying the identified harmonic using a narrowband filter.
